(19) United States
(12) Patent Application Publication
(10) Pub. No.: US 2022/0203639 A1
(43) Pub. Date: Jun. 30, 2022

(54) TIRE MOLDING APPARATUS

(71) Applicant: Toyo Tire Corporation, Itami-shi, Hyogo (JP)

(72) Inventors: Tomoyuki Kobayashi, Itami-shi (JP); Katsuji Niwa, Itami-shi (JP)

(73) Assignee: Toyo Tire Corporation, Itami-shi, Hyogo (JP)

(21) Appl. No.: 17/608,258

(22) PCT Filed: Aug. 13, 2020
(86) PCT No.: PCT/JP2020/030829

§ 371 Date: Nov. 2, 2021

(30) Foreign Application Priority Data
Sep. 2, 2019 (JP) 2019-159797

(51) Int. Cl. B29D 30/26

(52) U.S. Cl. CPC B29D 30/2607; B29D 2030/2671

(57) ABSTRACT

Provided is a tire molding apparatus capable of preventing a transfer device from continuing to swing after stop. The tire molding apparatus includes: a rail; and a transfer device configured to hold a tire member and move along the rail. The transfer device is configured to move along the rail and stop to receive or deliver the tire member. A positioning device is provided in the transfer device. The positioning device includes a concave portion and a convex portion. One of the concave portion and the convex portion is provided in the transfer device, and the other one of the concave portion and the convex portion is provided at a position facing the transfer device when the transfer device is stopped. The transfer device is stopped by fitting the concave portion to the convex portion.

### TECHNICAL FIELD

The present invention relates to a tire molding apparatus.

### BACKGROUND ART

As described in PTL 1 and PTL 2, a tire molding apparatus including a carcass drum, a belt drum, and a shaping drum is known. In the carcass drum, a carcass band, which is a tire member including a carcass, is molded. In the belt drum, an outer member, which is a tire member including a belt and a tread, is molded. In the shaping drum, the carcass band and the outer member are integrated to mold a green tire.

A transfer device is used for movement of a tire member between drums. Specifically, the transfer device receives the carcass band from the carcass drum, moves to a position of the shaping drum, and delivers the carcass band to the shaping drum. Another transfer device receives the outer member from the belt drum, moves to the position of the shaping drum, and delivers the outer member to the shaping drum.

These transfer devices move along a rail by a servo motor, and stop at a receiving position and a delivering position of the tire members. The transfer devices are stopped by control of the servo motor.

### CITATION LIST

### Patent Literature

PTL 1: JP-A-2006-116817
PTL 2: JP-A-2013-220636

### SUMMARY OF INVENTION

### Technical Problem

In order to improve production efficiency, it is preferable that the transfer devices are accelerated in a short time, move at a high speed, and are then decelerated and stopped in a short time. However, when the transfer devices suddenly stop after moving at a high speed, there is a problem that the transfer devices continue to swing even after stop. When the tire members are received or delivered while the transfer devices are swinging, the tire members cannot be finally attached to a correct position of the shaping drum in a correct posture, and uniformity of the tire is affected.

Accordingly, an object of the invention is to provide a tire molding apparatus capable of preventing a transfer device from continuing to swing after stop.

### Solution to Problem

A tire molding apparatus according to an embodiment including: a rail; and a transfer device configured to hold a tire member and move along the rail, in which the transfer device is configured to move along the rail and stop to receive or deliver the tire member, a positioning device is provided in the transfer device, the positioning device includes a concave portion and a convex portion, one of the concave portion and the convex portion is provided in the transfer device, the other one of the concave portion and the convex portion is provided at a position facing the transfer device when the transfer device is stopped, and the transfer device is stopped by fitting the concave portion to the convex portion.

### Advantageous Effects of Invention

According to the tire molding apparatus described above, after the transfer device is stopped, a part of the transfer device on a side opposite to the rail is fixed by the positioning device, and thus it is possible to prevent the transfer device from continuing to swing.

### BRIEF DESCRIPTION OF DRAWINGS

FIG. 1 is a plan view of an entire tire molding apparatus as viewed from above, in which drums and transfer devices are in their respective standby positions.

FIG. 2 is a plan view of the entire tire molding apparatus as viewed from above when a carcass drum and a first transfer device move to an intersection portion of a first rail and a fourth rail.

FIG. 3 is a plan view of the entire tire molding apparatus as viewed from above when the carcass drum returns to a standby position and the first transfer device moves to an intersection portion of the fourth rail and a second rail.

FIG. 4 is a plan view of the entire tire molding apparatus as viewed from the above when a shaping drum moves to the intersection portion of the fourth rail and the second rail.

FIG. 5 is a plan view of the entire tire molding apparatus as viewed from the above when the shaping drum and the first transfer device return to respective standby positions.

FIG. 6 is a plan view of the entire tire molding apparatus as viewed from the above when a second transfer device moves to the standby position of the shaping drum.

FIG. 7 is a view of the second transfer device as viewed in an axial direction at a delivering position of a belt member from the belt drum to the second transfer device. The belt drum is not shown.

FIG. 8 is a view of the second transfer device as viewed from a left side of FIG. 7.

FIG. 9 is an enlarged view of a cotter and its vicinity in FIG. 8.

FIG. 10 is a block diagram of a laser displacement meter, a storage device, and the like.

FIG. 11 is a diagram showing a first laser displacement meter and an upper reflector as viewed from the same direction as FIG. 8.

FIG. 12 is a diagram showing the first laser displacement meter and the upper reflector according to a modification as viewed from the same direction as FIG. 8.

FIG. 13 is a view of the second transfer device according to a modification as viewed from the same direction as in FIG. 7.

FIG. 14 is a view of the second transfer device according to a modification as viewed from the same direction as in FIG. 8.

FIG. 15 is a diagram showing a positioning device according to a modification as viewed from the same direction as FIG. 8.

FIG. 16 is a cross-sectional view taken along a line N-N in FIG. 15.

FIG. 17 is a plan view of the entire tire molding apparatus as viewed from the above according to a modification, in which drums and transfer devices are in their respective standby positions.

FIG. 18 is a front view (view seen from below in FIG. 17) of the entire tire molding apparatus according to the modification, in which the drums and the transfer devices are in their respective standby positions.

### DESCRIPTION OF EMBODIMENTS

An embodiment will be described with reference to the drawings. The embodiment described below is merely an example, and appropriate modifications without departing from the spirit of the invention are included in the scope of the invention.

1. Overall Configuration of Tire Molding Apparatus

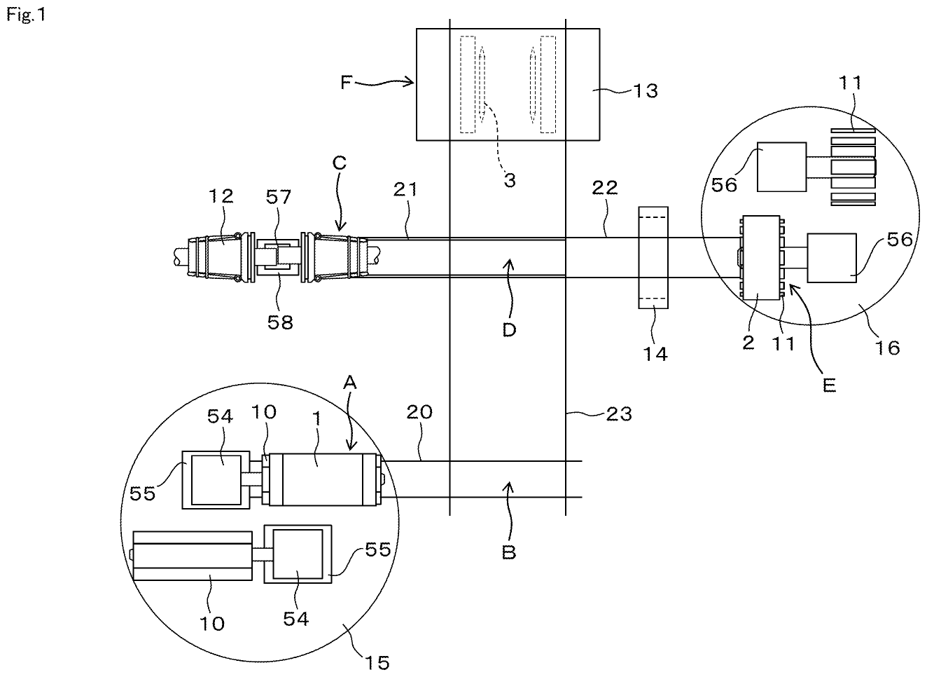

A layout of the tire molding apparatus of the present embodiment is shown in FIG. 1. The tire molding apparatus includes a carcass drum 10, a belt drum 11, and a shaping drum 12. The carcass drum 10, the belt drum 11, and the shaping drum 12 are disposed at positions separated from each other.

The carcass drum 10 is a drum having a known structure in which a plurality of segments are circumferentially arranged to form a cylindrical shape as a whole. When the plurality of segments move together in a drum radial direction, an outer circumferential surface of the carcass drum 10 expands and contracts in diameter. An inner liner, a carcass, or the like is attached to the outer circumferential surface of the carcass drum 10 to mold a cylindrical carcass band 1. The carcass band 1 is a type of tire member.

A rotation shaft of the carcass drum 10 is supported by a support base 54, and the support base 54 is mounted on a moving device 55 for moving along a rail described later.

The belt drum 11 is a drum having a known structure in which a plurality of segments are circumferentially arranged to form a cylindrical shape as a whole. When the plurality of segments move together in a drum radial direction, an outer circumferential surface of the belt drum 11 expands and contracts in diameter. A belt, a tread, or the like is attached to the outer circumferential surface of the belt drum 11 to mold a cylindrical belt member 2. The belt member 2 is a type of tire member. A rotation shaft of the belt drum 11 is supported by a support base 56.

The shaping drum 12 is a drum having a known structure for shaping. A center portion in an axial direction of the shaping drum 12 is supported by a support base 57, and the support base 57 is mounted on a moving device 58 for moving along a rail described later.

The carcass band 1 molded by the carcass drum 10 is transferred to the shaping drum 12 and set on an outer circumferential surface of the shaping drum 12. The belt member 2 molded by the belt drum 11 is also transferred to the shaping drum 12, and is disposed on an outer circumferential side of the carcass band 1 set on the shaping drum 12. The carcass band 1 is formed into a toroidal shape by shaping in this state, and the belt member 2 is attached to the carcass band 1 to mold a green tire.

The tire molding apparatus further includes a first transfer device 13 and a second transfer device 14. The first transfer device 13 is a device that receives the carcass band 1 from the carcass drum 10 and delivers the carcass band 1 to the shaping drum 12. The first transfer device 13 has a known structure in which a plurality of segments are circumferentially arranged to form a cylinder, and these segments can advance and retract in a radial direction at the same time. When the plurality of segments advance to an inner diameter side, the carcass band 1 can be gripped from an outer diameter side.

The second transfer device 14 is a device that receives the belt member 2 from the belt drum 11 and delivers the belt member 2 to the shaping drum 12. The second transfer device 14 has a known structure in which a plurality of segments are circumferentially arranged to form a cylinder, and these segments can advance and retract in a radial direction at the same time. When the plurality of segments advance to an inner diameter side, the belt member 2 can be gripped from an outer diameter side.

As rails for the drums and transfer devices to move, a first rail 20, a second rail 21, a third rail 22, and a fourth rail 23 are provided. The first rail 20, the second rail 21, and the third rail 22 are all linear rails and are arranged in parallel. The fourth rail 23 is a linear rail, is orthogonal to the first rail 20, the second rail 21, and the third rail 22, and intersects the first rail 20, the second rail 21, and the third rail 22 in a plan view.

The first rail 20 is a pair of two rails, and is disposed on a table on a floor. The first rail 20 extends at least from a standby position (indicated by A in the drawing) of the carcass drum 10 to an intersection portion (indicated by B in the drawing) with the fourth rail 23. The carcass drum 10 is movable on the first rail 20.

The second rail 21 is a pair of two rails, and is disposed on a table on the floor. The second rail 21 extends at least from a standby position (indicated by C in the drawing) of the shaping drum 12 to an intersection portion (indicated by D in the drawing) with the fourth rail 23. The shaping drum 12 is movable on the second rail 21.

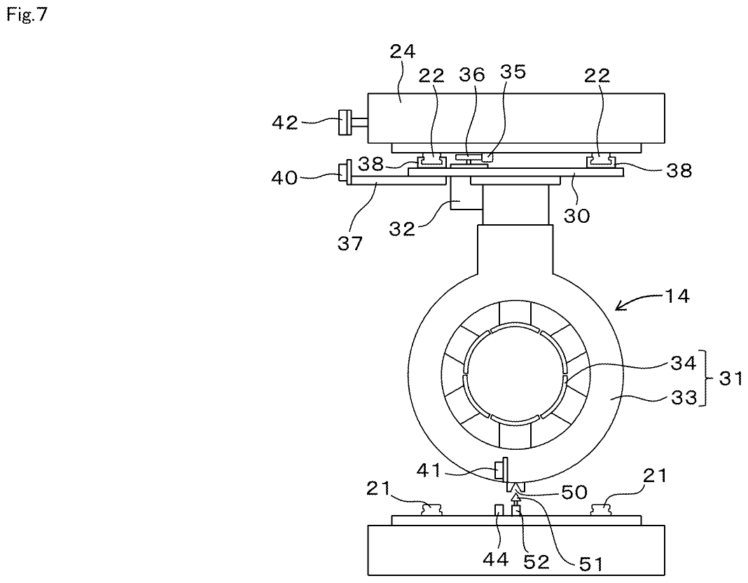

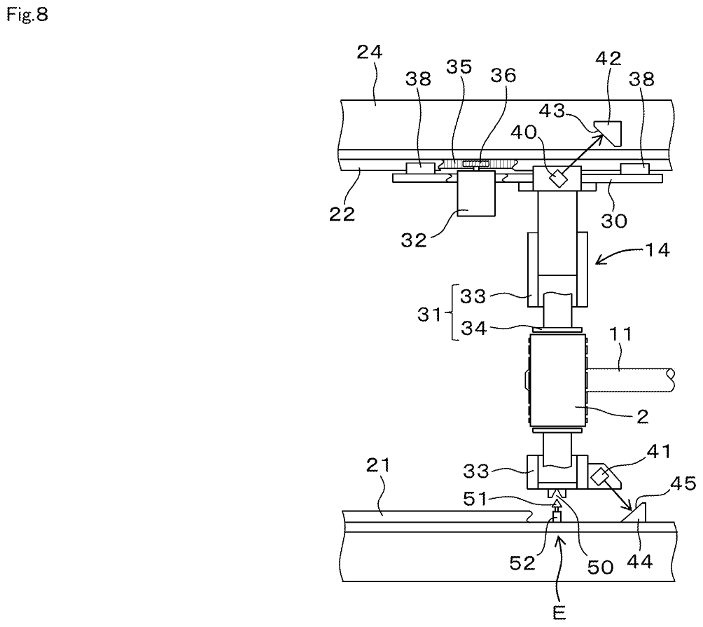

The third rail 22 is a pair of two rails, and is provided not on the floor but on a lower surface of an upper frame 24 (see FIG. 7) disposed on an upper side. The third rail 22 extends at least from the standby position C of the shaping drum 12 to a position (indicated by E in the drawing) of the belt drum 11 beyond the intersection portion D with the fourth rail 23. The second transfer device 14 is suspended from the third rail 22 (see FIGS. 7 and 8 for details) and is movable along the third rail 22.

The fourth rail 23 is a pair of two rails, and is provided not on the floor but on a lower surface of an upper frame (not shown) disposed on the upper side. The fourth rail 23 extends from a standby position (indicated by F in the drawing) of the first transfer device 13 to the intersection portion B with the first rail 20 beyond the intersection portion D with the second rail 21 and the third rail 22. The first transfer device 13 is suspended from the fourth rail 23, and is movable along the fourth rail 23.

The intersection portion B between the first rail 20 and the fourth rail 23 is a delivering position of the carcass band 1 from the carcass drum 10 to the first transfer device 13. The intersection portion D between the second rail 21 and the fourth rail 23 is a delivering position of the carcass band 1 from the first transfer device 13 to the shaping drum 12. The position E of the belt drum 11 is also a delivering position of the belt member 2 from the belt drum 11 to the second transfer device 14. The standby position C of the shaping drum 12 is also a delivering position of the belt member 2 from the second transfer device 14 to the shaping drum 12.

In the tire molding apparatus, two carcass drums 10 are provided. The two carcass drums 10 are disposed on a circular rotary table 15 in opposite directions with their axial directions parallel to each other. When the carcass drum 10 is on a side opposite to the fourth rail 23 (left side in FIG. 1), the carcass band 1 is molded on the outer circumferential surface of the carcass drum 10. Thereafter, the rotary table 15 is rotated by 180°, the carcass drum 10 is moved to the fourth rail 23 side (right side in FIG. 1), and an operation for delivering the carcass band 1 from the carcass drum 10 to the first transfer device 13 is performed.

Two belt drums 11 are also provided. The two belt drums 11 are disposed on a circular rotary table 16 in opposite directions with their axial directions parallel to each other. When the belt drum 11 is on a side opposite to the second transfer device 14 (right side in FIG. 1), the belt member 2 is molded on the outer circumferential surface of the belt drum 11. Thereafter, the rotary table 16 is rotated by 180°, the belt drum 11 is moved to the second transfer device 14 side (left side in FIG. 1), and an operation for transferring the belt member 2 from the belt drum 11 to the second transfer device 14 is performed.

The carcass drums 10, the belt drums 11, the shaping drum 12, the first transfer device 13, and the second transfer device 14 are arranged such that the axial directions are oriented in the same direction except during rotation of the rotary tables 15 and 16. The axial directions of the drums and the transfer devices are parallel to the extending directions of the first rail 20, the second rail 21, and the third rail 22. The shaping drum 12, the second transfer device 14, and the belt drum 11 on the fourth rail 23 side are coaxial.

2. Outline of Tire Molding Method

Before entering a detailed description, an outline of a tire molding method in such a tire molding apparatus will be described with reference to FIGS. 1 to 6.

First, the carcass drums 10, the belt drums 11, the shaping drum 12, the first transfer device 13, and the second transfer device 14 stand by at respective standby positions shown in FIG. 1. At this time, it is assumed that the carcass drum 10 having the carcass band 1 molded on the outer circumferential surface thereof has already been moved to the fourth rail 23 side. It is assumed that the belt drum 11 having the belt member 2 molded on the outer circumferential surface thereof has already been moved to the second transfer device 14 side. It is assumed that the first transfer device 13 holds a bead 3.

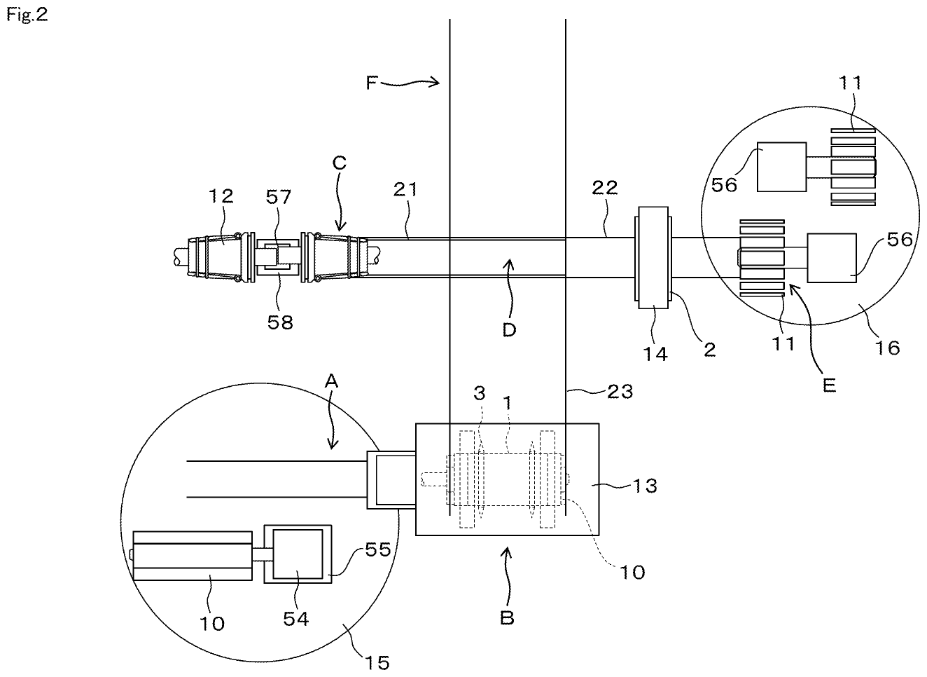

Next, as shown in FIG. 2, the first transfer device 13 moves from the standby position F to the intersection portion B between the first rail 20 and the fourth rail 23, and then the carcass drum 10 moves to the same intersection portion B. At this time, the carcass drum 10 enters an inside of the segments arranged in a circular shape of the first transfer device 13. Then, the segments of the first transfer device 13 contract in diameter to hold the carcass band 1 from the outer diameter side, and the segments of the carcass drum 10 contract in diameter to separate from the carcass band 1. Thus, delivery of the carcass band 1 from the carcass drum 10 to the first transfer device 13 is completed.

During this delivery, in the first transfer device 13, the bead 3 is disposed on the outer diameter side of the carcass band 1, and the carcass band 1 and the bead 3 are integrated. Thereafter, the carcass band 1 and the beads 3 move together.

In parallel with the delivery of the carcass band 1 from the carcass drum 10 to the first transfer device 13, the delivery of the belt member 2 from the belt drum 11 to the second transfer device 14 is also performed.

Specifically, the second transfer device 14 moves to the outer diameter side of the belt member 2 held by the belt drum 11. Then, segments 34 (see FIGS. 7 and 8) of the second transfer device 14 contract in diameter to hold the belt member 2 from the outer diameter side, and the belt drum 11 contracts in diameter to separate from the belt member 2. The second transfer device 14 that has received the belt member 2 from the belt drum 11 stands by at a standby position near the belt drum 11.

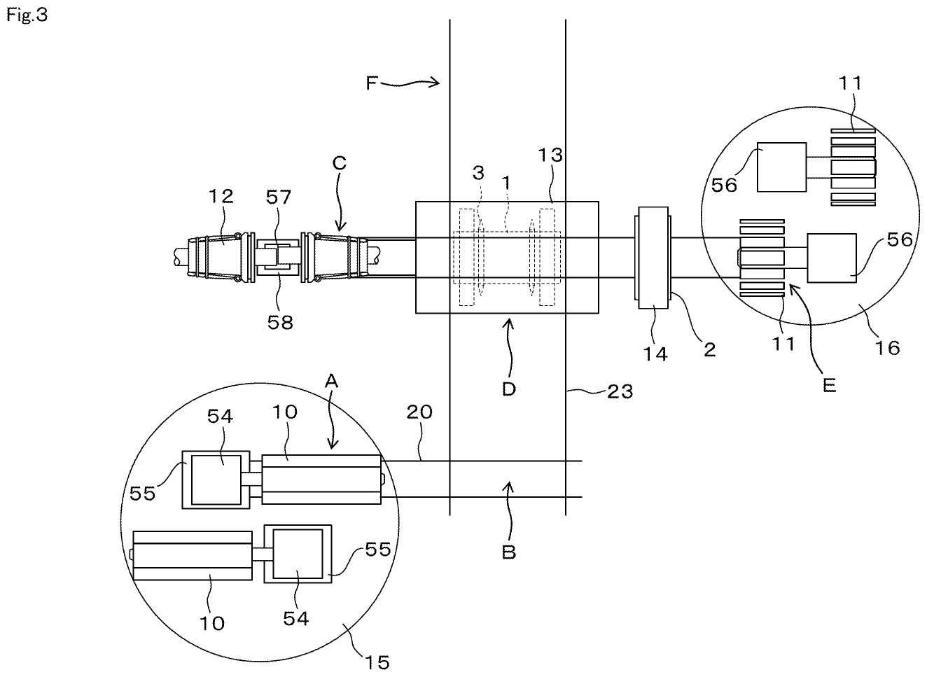

Next, as shown in FIG. 3, the carcass drum 10 returns to the standby position A, and then the first transfer device 13 moves to the intersection portion D between the fourth rail 23 and the second rail 21 while holding the carcass band 1.

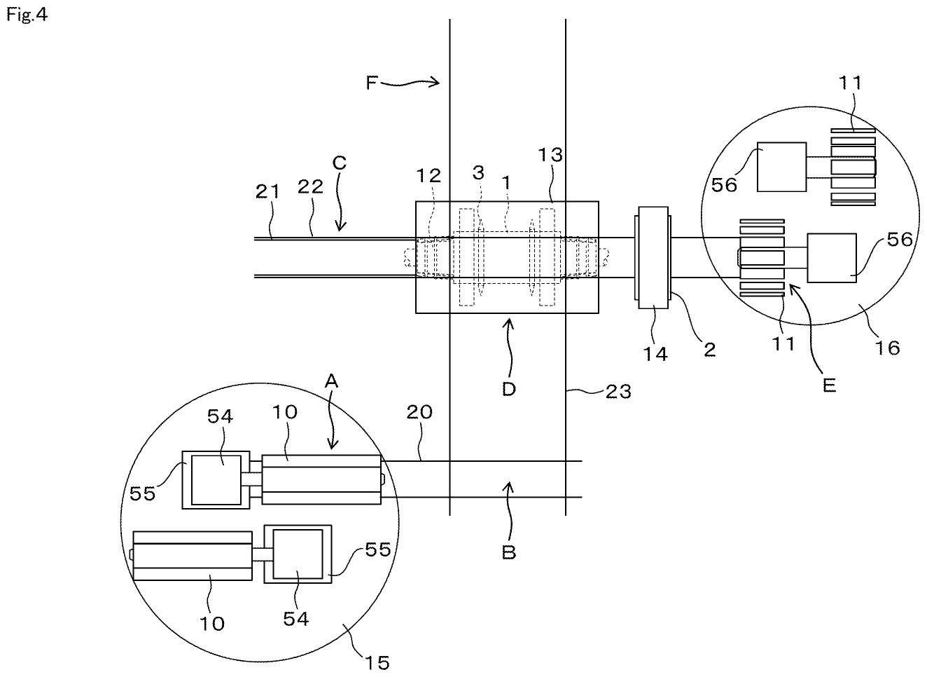

Next, as shown in FIG. 4, the shaping drum 12 moves to the intersection portion D between the fourth rail 23 and the second rail 21. At this time, the shaping drum 12 enters an inside of the carcass band 1 held by the first transfer device 13. Then, the segments of the shaping drum 12 expand in diameter to hold the carcass band 1 on the outer circumferential surface thereof, and the segments of the first transfer device 13 expand in diameter to separate from the carcass band 1. Thus, the delivery of the carcass band 1 from the first transfer device 13 to the shaping drum 12 is completed.

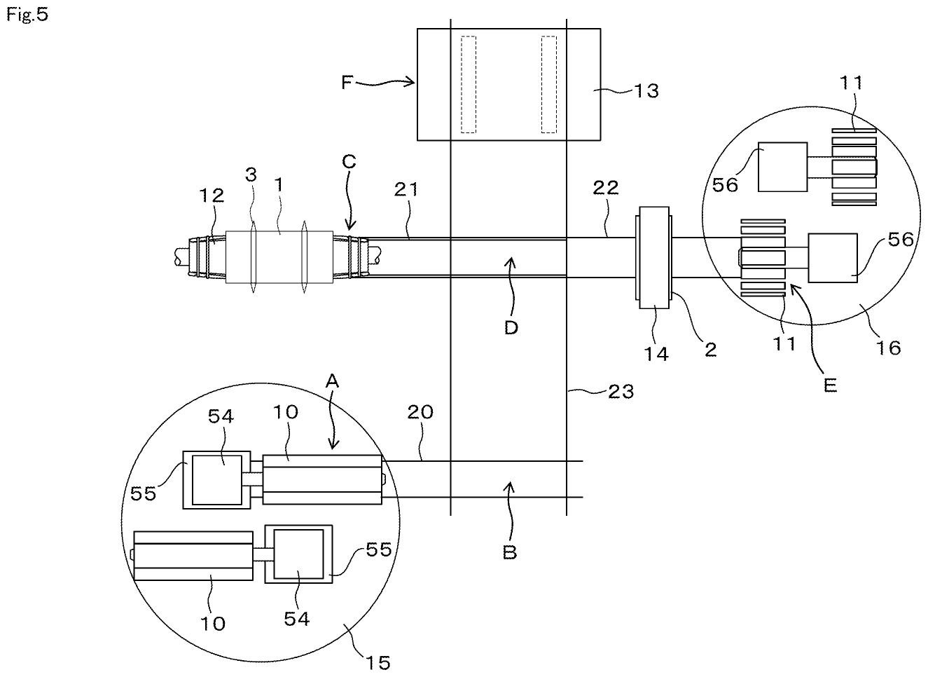

Next, as shown in FIG. 5, the shaping drum 12 returns to the standby position C while holding the carcass band 1, and then the first transfer device 13 returns to the standby position F.

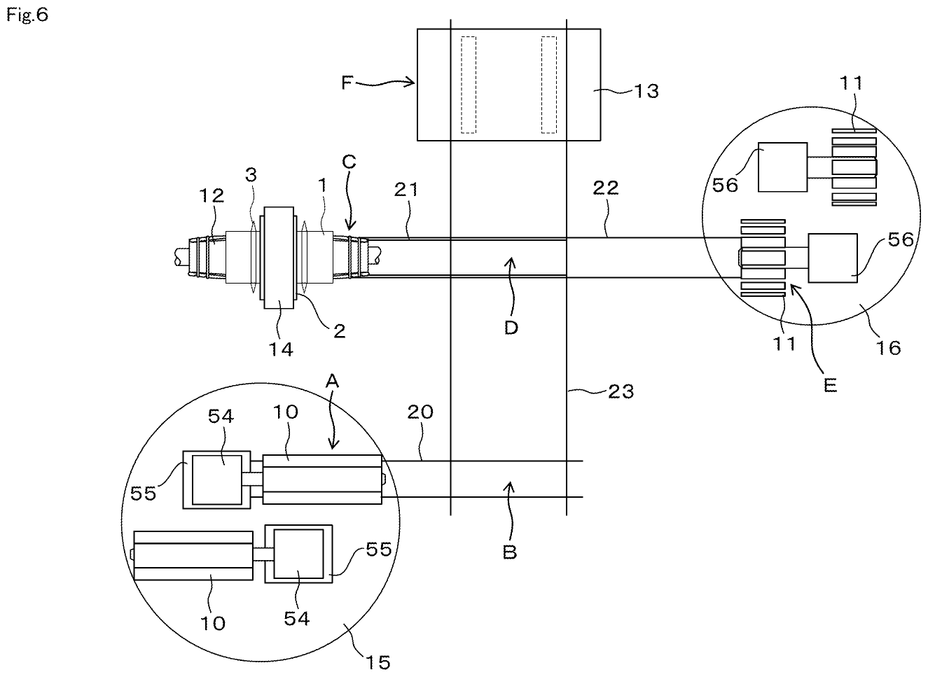

Next, as shown in FIG. 6, the second transfer device 14 moves to the standby position C of the shaping drum 12 while holding the belt member 2. As a result, the belt member 2 is disposed on the outer circumferential side of the carcass band 1 held by the shaping drum 12. Thereafter, shaping is performed to expand the center portion in the axial direction of the carcass band 1, and the belt member 2 is attached to the outer circumferential surface of the carcass band 1. Furthermore, turn-up in which the carcass band 1 is folded back at the position of the bead 3 is also performed. As a result, a green tire is completed.

The completed green tire is inserted into a mold (not shown) for vulcanization molding and is vulcanization molded. After the vulcanization molding, a pneumatic tire is completed after necessary processing such as inspection.

3. Second Transfer Device and Circumferential Structure Thereof

Next, a configuration related to movement and stop of the second transfer device 14 will be described.

As shown in FIGS. 7 and 8, in the second transfer device 14, a holding device 31 and a servo motor 32 are fixed to a lower surface side of a base plate 30.

The holding device 31 includes a frame member 33 having a circular shape when viewed from the axial direction, and the plurality of segments 34 provided on an inner diameter side of the frame member 33. The plurality of segments 34 are disposed in a circular shape along an inner diameter of the frame member 33. The segments 34 simultaneously advance in a direction in which the circle contracts in diameter or retract in a direction in which the circle expands. When the segments 34 advance, the belt member 2 disposed inside the circle formed by the segments 34 can be held. The holding device 31 has a thin shape, and for example, a thickness of the frame member 33 (length of the holding device 31 in the axial direction) is equal to or less than ⅓ of a diameter of the frame member 33.

A plurality of slide members 38 are fixed to an upper surface of the base plate 30 in two rows as shown in FIG. 7. The slide members 38 hold the two third rails 22 above the second transfer device 14, respectively. The slide members 38 are slidable with respect to the third rails 22. With this structure, the second transfer device 14 is slidable along the two third rails 22.

A rack 35 extending parallel to the third rails 22 is provided above the second transfer device 14. A pinion 36 is provided on an output shaft of the servo motor 32 of the second transfer device 14. The pinion 36 meshes with the rack 35. With such a structure, when the servo motor 32 drives, the second transfer device 14 as a whole moves along the third rails 22 due to the action of the pinion 36 and the rack 35. The movement and stop of the second transfer device 14 are performed by the control of the servo motor 32.

An extension member 37 that is a part of the second transfer device 14 extends from the base plate 30 of the second transfer device 14 in a direction orthogonal to the axial direction of the holding device 31 in a plan view. A first laser displacement meter 40 that is a sensor is fixed to an extension destination of the extension member 37. A second laser displacement meter 41 that is a sensor is fixed to a lower portion of the frame member 33 of the holding device 31. The first laser displacement meter 40 and the second laser displacement meter 41 are sensors that measure a distance to a reflector to be described later.

On the other hand, at the delivering position E of the belt member 2 from the belt drum 11 to the second transfer device 14 and the delivering position C of the belt member 2 from the second transfer device 14 to the shaping drum 12, which are stop positions of the second transfer device 14, reflectors are fixed at positions facing the second transfer device 14 when the second transfer device 14 is stopped.

Here, an arrangement of the reflectors at the delivering position E of the belt member 2 from the belt drum 11 to the second transfer device 14 will be described with reference to FIGS. 7 and 8. At the delivering position E, an upper reflector 42 is fixed to a side surface of the upper frame 24 holding the third rails 22. The upper reflector 42 is located above the third rails 22, so that the position of the upper reflector 42 is outside a movable range of the second transfer device 14. That is, even if the second transfer device 14 moves along the third rails and passes below the upper reflector 42, the second transfer device 14 does not come into contact with the upper reflector 42.

As shown in FIG. 8, the upper reflector 42 has a reflective surface 43 that is inclined with respect to an extending direction (also a moving direction of the second transfer device 14) of the third rails 22. The reflective surface 43 faces downward in a direction toward which the second transfer device 14 approaches. The reflective surface 43 faces the first laser displacement meter 40 of the second transfer device 14 when the second transfer device 14 is stopped at the delivering position E.

On the other hand, the first laser displacement meter 40 is fixed in such a direction to measure a distance to the reflective surface 43 of the upper reflector 42 when the second transfer device 14 is stopped at the delivering position E. In the present embodiment, it is assumed that a measurement direction of the first laser displacement meter 40 is perpendicular to the reflective surface 43 of the upper reflector 42.

A lower reflector 44 is disposed on the floor of the delivering position E. The lower reflector 44 is disposed below the movable range of the second transfer device 14. That is, even if the second transfer device 14 moves along the third rails 22 and passes above the lower reflector 44, the second transfer device 14 does not come into contact with the lower reflector 44.

The lower reflector 44 has a reflective surface 45 that is inclined with respect to an extending direction (also a moving direction of the second transfer device 14) of the third rail 22. The reflective surface 45 faces upward in a direction toward which the second transfer device 14 approaches. The reflective surface 45 faces the second laser displacement meter 41 of the second transfer device 14 when the second transfer device 14 is stopped at the delivering position E.

On the other hand, the second laser displacement meter 41 is fixed in such a direction to measure a distance to the reflective surface 45 of the lower reflector 44 when the second transfer device 14 is stopped at the delivering position E. In the present embodiment, it is assumed that a measurement direction of the second laser displacement meter 41 is perpendicular to the reflective surface 45 of the lower reflector 44.

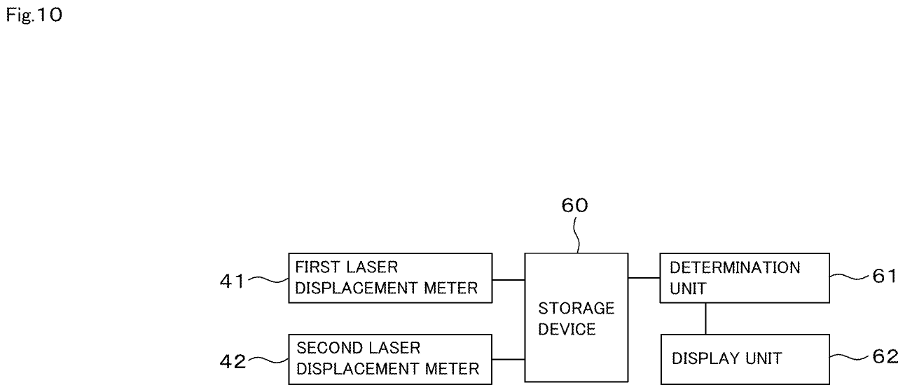

With such a configuration, when the second transfer device 14 stops at the delivering position E, the first laser displacement meter 40 can measure the distance to the reflective surface 43 of the upper reflector 42, and the second laser displacement meter 41 can measure the distance to the reflective surface 45 of the lower reflector 44. The first laser displacement meter 40 and the second laser displacement meter 41 are connected to the storage device (see FIG. 10), and the distances measured by the first laser displacement meter 40 and the second laser displacement meter 41 are stored in the storage device 60.

Similarly, also at the delivering position C of the belt member 2 from the second transfer device 14 to the shaping drum 12, an upper reflector (not shown) having the same shape as the upper reflector 42 and a lower reflector (not shown) having the same shape as the lower reflector 44 are disposed in a position outside the movable range of the second transfer device 14.

Then, when the second transfer device 14 stops at the delivering position C, the first laser displacement meter 40 can measure a distance to a reflective surface of the upper reflector, and the second laser displacement meter 41 can measure a distance to a reflective surface of the lower reflector. Then the distances measured by the first laser displacement meter 40 and the second laser displacement meter 41 are stored in the storage device 60.

A concave portion 50 that is a part of a positioning device is formed in a lower portion of the frame member 33 of the holding device 31, that is, in a part of the second transfer device 14 on a side opposite to the third rails 22. At the delivering position E of the belt member 2 from the belt drum 11 to the second transfer device 14 and the delivering position C of the belt member 2 from the second transfer device 14 to the shaping drum 12, which are stop positions of the second transfer device 14, a cotter 51 is provided respectively as a part of the positioning device. Specifically, the cotter 51 is provided at a position facing the concave portion 50 when the second transfer device 14 is stopped at the stop positions C and E under the control of the servo motor 32.

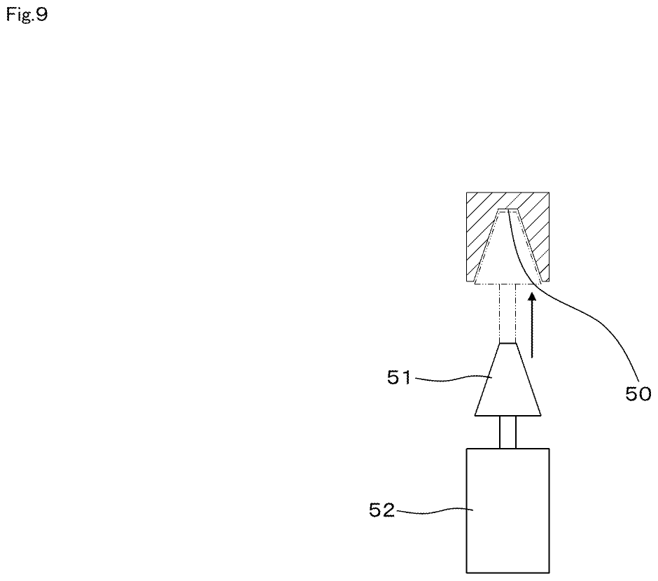

As shown in FIG. 9, the cotter 51 is a wedge-shaped convex portion. The cotter 51 advances and retracts by a cylinder 52. When the second transfer device 14 is not at the stop position C or E, the cotter 51 retracts outside the movable range of the second transfer device 14, as indicated by a solid line in FIG. 9. However, when the second transfer device 14 stops at the stop positions C and E, the cotter 51 advances toward the concave portion 50 and fits into the concave portion 50 as indicated by a two-dot chain line in FIG. 9. Thus, the position of the second transfer device 14 is fixed at a position on a side opposite to the third rails 22.

Driving of the servo motor 32 and advance and retraction movement of the cotter 51 are controlled by a control unit (not shown). As shown in FIG. 10, a determination unit 61 is connected to the storage device 60, and a display unit 62 is connected to the determination unit 61. Sensors such as the first laser displacement meter 40 and the second laser displacement meter 41 are connected to the storage device 60.

4. Movement and Stop of Second Transfer Device

The second transfer device 14 moves along the third rails 22 when the servo motor 32 drives, and stops when the servo motor 32 stops. The stop position of the second transfer device 14 is determined by control of the servo motor 32.

The stop of the second transfer device 14 will be described by taking, as an example, the stop of the belt member 2 at the delivering position E from the belt drum 11 to the second transfer device 14. First, the second transfer device 14, which has moved from the standby position to the belt drum 11 along the third rails 22, stops at the delivering position E as shown in FIG. 8 when the servo motor 32 stops.

Next, the cotter 51 advances upward and is fitted into the concave portion 50 of the frame member 33. As a result, the movement of the second transfer device 14 is stopped not only by an electrical method of stopping the servo motor 32, but also by a mechanical method of the positioning device. In addition to an upper portion of the second transfer device 14 being held by the third rails 22 and stopped, the lower portion of the second transfer device 14 is also stopped undisplaceably by the cotter 51.

Next, the first laser displacement meter 40 measures the distance to the reflective surface 43 of the upper reflector 42, and transmits a measurement result to the storage device 60. Next, the second laser displacement meter 41 measures the distance to the reflective surface 45 of the lower reflector 44, and transmits a measurement result to the storage device 60.

The first laser displacement meter 40 and the second laser displacement meter 41 may continuously perform a measurement just before the second transfer device 14 stops. Also in this case, at least a measurement result obtained when the cotter 51 is fitted into the concave portion 50 and the second transfer device 14 is completely stopped is transmitted to the storage device 60.

During production of a large number of green tires, the second transfer device 14 stops at the delivering position E plural times. Every time the second transfer device 14 stops at the delivering position E, the measurement results of the first laser displacement meter and the second laser displacement meter 41 are transmitted to the storage device 60 in this manner, and the measurement results are accumulated.

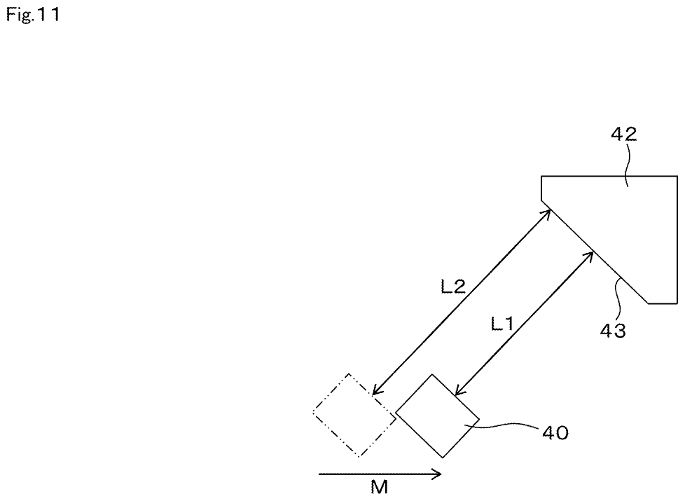

Here, when the second transfer device 14 stops at a regular stop position, the laser displacement meters 40 and 41 also stop at the regular position (positions indicated by a solid line in FIG. 11). However, when the second transfer device 14 stops at a position deviated from the regular stop position, the laser displacement meters 40 and also stop at a position deviated from the regular position (for example, a position indicated by a two-dot chain line in FIG. 11).

As indicated by L1 and L2 in FIG. 11, the distances from the laser displacement meters 40 and 41 to the reflectors 42 and 44 also vary between when the second transfer device 14 stops at the regular stop position and when the second transfer device 14 stops at a position deviated from the regular stop position. Therefore, when the stop position of the second transfer device 14 is deviated, the measurement results measured by the laser displacement meters 40 and 41 and acquired in the storage device 60 are also changed. An arrow M in FIG. 11 indicates a moving direction of the first laser displacement meter 40.

In this way, the first laser displacement meter 40 and the upper reflector 42 form a set to constitute a position information acquisition device that acquires information on the stop position of the second transfer device 14. Similarly, the second laser displacement meter 41 and the lower reflector 44 form a set to constitute a position information acquisition device that acquires information on the stop position of the second transfer device 14.

Also at the delivering position C of the belt member 2 from the second transfer device 14 to the shaping drum 12, after the second transfer device 14 is stopped in the same manner as described above, the first laser displacement meter 40 and the second laser displacement meter 41 measure the distances to the reflective surfaces of the upper and lower reflectors and transmit the measurement results to the storage device 60. Every time the second transfer device 14 stops at the delivering position C, the measurement results of the first laser displacement meter and the second laser displacement meter 41 are transmitted to the storage device 60, and the measurement results are accumulated.

Based on the measurement results stored in the storage device 60, the determination unit 61 determines whether the stop position of the second transfer device 14 is deviated from the regular stop position beyond an allowable range, and determines whether the stop position of the second transfer device 14 has a tendency to change. Then, the determination result is displayed on the display unit 62.

However, even when the determination unit 61 and the display unit 62 are not provided, when a person sees the measurement results accumulated in the storage device 60, the person can notice that the stop position of the second transfer device 14 is deviated from the regular position beyond the allowable range or that there is a tendency for the stop position of the second transfer device 14 to change.

5. Effects of Embodiment

Next, effects of the present embodiment will be described.

As described above, the tire molding apparatus of the present embodiment is provided with the positioning device including the concave portion 50 and the cotter 51, the concave portion 50 is provided in a part of the second transfer device 14 on a side opposite to the third rails 22 (that is, a lower portion of the holding device 31 of the second transfer device 14), and the cotter 51 is provided at a position facing the second transfer device 14 when the second transfer device 14 is stopped. Then, when the second transfer device 14 stops, the cotter 51 advances and fits into the concave portion 50. Therefore, even when the second transfer device 14 suddenly stops after moving at a high speed, it is possible to prevent the second transfer device 14 from continuing to swing after the second transfer device 14 stops.

Here, when the holding device 31 of the second transfer device 14 has a thin shape, a part of the second transfer device 14 that is not held by the third rails 22, that is, a lower portion of the holding device 31, is particularly likely to swing significantly. However, in the present embodiment, since the concave portion 50 is provided in the lower portion of the holding device 31 and the cotter 51 is fitted into the concave portion 50, it is possible to effectively stop the swing of the lower portion of the holding device 31.

Although in the present embodiment, the second transfer device 14 is moved and stopped by the control of the servo motor 32, the second transfer device 14 can be not only electrically stopped by the stop of the servo motor 32, but also mechanically stopped by using the cotter 51.

Since the second transfer device 14 is stopped by two methods as described above, when an abnormality occurs in one of the two methods, the determination unit 61 or a person can notice the abnormality. For example, when the abnormality occurs in the servo motor 32 and the second transfer device 14 does not stop at the regular position, the cotter 51 is not fitted into the concave portion 50, and thus the determination unit 61 or the person can notice the abnormality. When an abnormality occurs on a cotter 51 side, such as a position deviation of the cotter 51, a problem such as a position deviation of the servo motor 32 occurs even if the cotter 51 is fitted into the concave portion 50, and thus the determination unit 61 or the person can notice the abnormality.

As described above, the upper reflector 42 and the lower reflector 44 are provided at positions facing the second transfer device 14 when the second transfer device 14 is stopped, and the first laser displacement meter 40 and the second laser displacement meter 41 are provided in the second transfer device 14. Then, the first laser displacement meter 40 measures the distance to the upper reflector 42, the second laser displacement meter 41 measures the distance to the lower reflector 44, and the respective measurement results are acquired as information on the stop position of the second transfer device 14.

As described above, according to the present embodiment, information on the stop position of the second transfer device 14 can be acquired without stopping and inspecting the tire molding apparatus. Then, based on the acquired information, it can be noticed that the stop position of the second transfer device 14 is deviated from the regular position beyond the allowable range or that there is a tendency for the stop position of the second transfer device 14 to change. If the stop position of the second transfer device 14 tends to change, it can be predicted that the deviation of the stop position of the second transfer device 14 will exceed the allowable range in the near future.

Therefore, the operator can repair or maintain the second transfer device 14 without delay so that the second transfer device 14 can stop at the regular position. For example, if the stop position of the second transfer device 14 is deviated due to wear of the cotter 51 or deviation of the position of the cotter 51, the operator may update the cotter 51 or return the position of the cotter 51 to an original position.

When the second transfer device 14 stops at the regular position, the delivery of the belt member 2 from the belt drum 11 to the second transfer device 14 and the delivery of the belt member 2 from the second transfer device 14 to the shaping drum 12 are always performed at the regular position in a correct posture. Therefore, the belt member 2 can always be attached to a correct position of the carcass band 1 on the shaping drum 12 in a correct posture, and thus the uniformity of the completed pneumatic tire can be improved.

Here, since two sensors of the first laser displacement meter 40 and the second laser displacement meter 41 are provided as sensors for acquiring information on the stop position of the second transfer device 14, the measurement results of the two sensors do not match when one sensor fails, and the determination unit 61 or the person can notice that one sensor fails. Even if one sensor fails, the other sensor can continue acquiring a correct measurement result.

In the present embodiment, since the upper reflector 42 and the lower reflector 44 are disposed at positions outside the movable range of the second transfer device 14, there is no risk that the second transfer device 14 will collide with the upper reflector 42 and the lower reflector 44 even if control is performed to cause the second transfer device 14 to pass through the positions of the upper reflector 42 and the lower reflector 44.

In the present embodiment, the reflective surface 43 of the upper reflector 42 and the reflective surface 45 of the lower reflector 44 are inclined with respect to the extending direction of the third rails 22. Therefore, as shown in FIG. 11, when the stop position of the second transfer device 14 on the third rails 22 is different, the distance from the first laser displacement meter 40 to the reflective surface 43 of the upper reflector 42 and the distance from the second laser displacement meter 41 to the reflective surface 45 of the lower reflector 44 are different from each other. Therefore, the information on the stop position of the second transfer device 14 can be reliably acquired based on the measured distances of the first laser displacement meter 40 and the second laser displacement meter 41.

6. Modifications

Next, modifications will be described. Various modifications can be made to the above embodiment without departing from the spirit of the invention. A plurality of modifications will be described below, any one of the plurality of modifications described below may be applied to the above embodiment, or any two or more of the modifications described below may be applied in combination. Various modifications in addition to the following modifications are possible.

(1) First Modification

As a transfer device that holds and moves and stops a tire member, there is the first transfer device 13 in addition to the second transfer device 14 described in the above embodiment. The first transfer device 13 holds the carcass band 1 and moves along the fourth rail 23 in a direction orthogonal to the axial direction of the first transfer device 13.

Information on the stop position of the first transfer device 13 can also be acquired in the same manner as in the above embodiment. That is, the first transfer device 13 is provided with a laser displacement meter in the same manner as in the above-described embodiment. At the delivering position B of the carcass band 1 from the carcass drum 10 to the first transfer device 13 and the delivering position D of the carcass band 1 from the first transfer device 13 to the shaping drum 12, which are stop positions of the first transfer device 13, reflectors are provided at positions facing the first transfer device 13 when the first transfer device 13 is stopped.

Then, when the first transfer device 13 stops at these stop positions, the laser displacement meter measures a distance to a reflective surface of the reflector, and a measurement result is acquired in the storage device 60. Every time the first transfer device 13 stops at these stop positions, the measurement results by the laser displacement meter are acquired and accumulated in the storage device 60.

(2) Second Modification

In the above-described embodiment, the first laser displacement meter 40 and the second laser displacement meter 41 are provided in the second transfer device 14, and the upper reflector 42 and the lower reflector 44 are provided at positions facing the second transfer device 14 at the stop positions of the second transfer device 14. Alternatively, such arrangements may be reversed.

That is, the upper reflector 42 and the lower reflector 44 may be provided in the second transfer device 14, and the first laser displacement meter 40 and the second laser displacement meter 41 may be provided at positions facing the second transfer device 14 at the stop positions of the second transfer device 14.

(3) Third Modification

A sensor for measuring the distance to the upper reflector 42 or the lower reflector 44 is not limited to a laser displacement meter. As the sensor, a sensor capable of measuring the distance to the reflectors 42 and 44 by emitting a wave and reflecting the wave by the reflectors 42 and 44 is preferable. Examples of the wave emitted by the sensor include an electromagnetic wave and a sound wave, and examples of the electromagnetic wave include light, a radio wave, and an X-ray.

(4) Fourth Modification

The number of laser displacement meters provided in the second transfer device 14 is not limited to two as in the above embodiment, and may be one or three or more. The same number of reflectors as the number of laser displacement meters provided in the second transfer device 14 are provided at the stop positions of the second transfer device 14.

(5) Fifth Modification

Although in the above embodiment, the measurement directions of the laser displacement meters 40 and 41 are perpendicular to the reflective surfaces 43 and 45 of the reflectors 42 and 44, the measurement directions of the laser displacement meters 40 and 41 may be directed in other directions.

In the above embodiment, the reflective surfaces 43 and 45 of the reflectors 42 and 44 are inclined with respect to the extending direction (also the moving direction of the second transfer device 14) of the third rails 22 to face the direction toward which the second transfer device 14 approaches.

In this case, the measurement direction of the laser displacement meters 40 and 41 may be a direction perpendicular to the extending direction of the third rails 22. That is, the measurement direction of the first laser displacement meter 40 may be directed upward, and the measurement direction of the second laser displacement meter 41 may be directed downward.

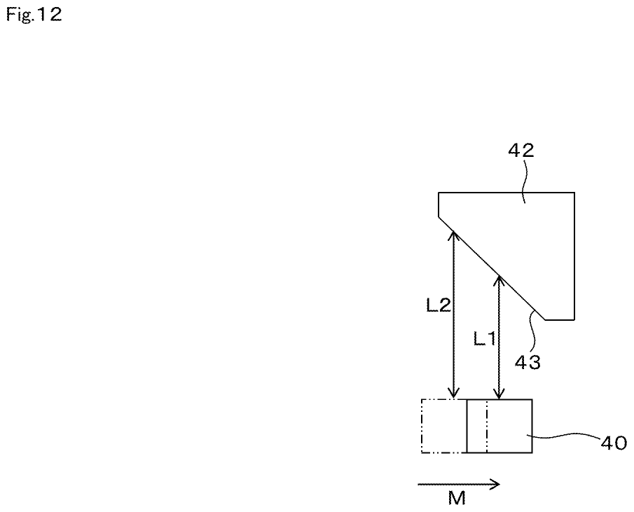

FIG. 12 shows a state in which the measurement direction of the first laser displacement meter 40 is directed upward. An arrow M in FIG. 12 indicates a moving direction of the second transfer device 14.

When the second transfer device 14 stops at a regular stop position, the first laser displacement meter 40 also stops at the regular position (position indicated by a solid line in FIG. 12). However, when the second transfer device stops at a position deviated from the regular stop position, the first laser displacement meters 40 also stops at a position deviated from the regular position (for example, a position indicated by a two-dot chain line in FIG. 12). As indicated by L1 and L2 in FIG. 12, the distance from the first laser displacement meter 40 to the upper reflector 42 also varies between when the second transfer device 14 stops at the regular stop position and when the second transfer device 14 stops at a position deviated from the regular stop position. Therefore, when the stop position of the second transfer device 14 is deviated, the measurement result measured by the first laser displacement meter 40 and acquired in the storage device 60 is also changed.

(6) Sixth Modification

The shape of the reflector is not limited to the shape having the inclined reflective surfaces 43 and 45 as in the above-described embodiment.

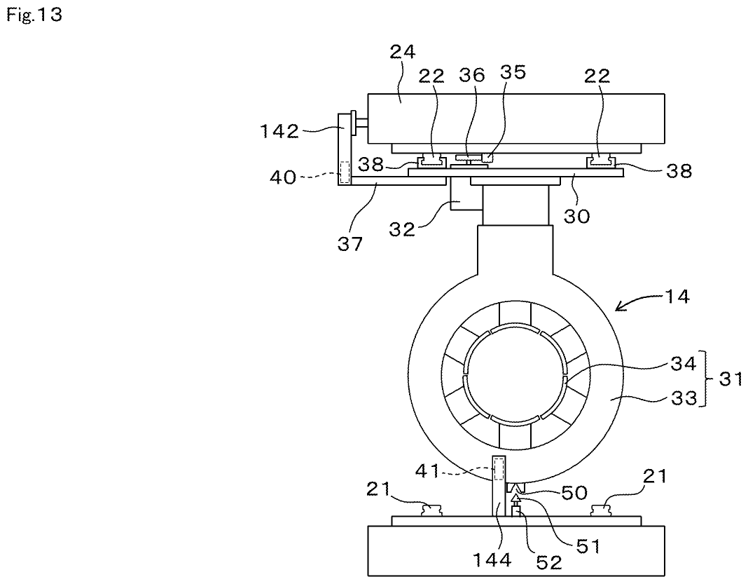

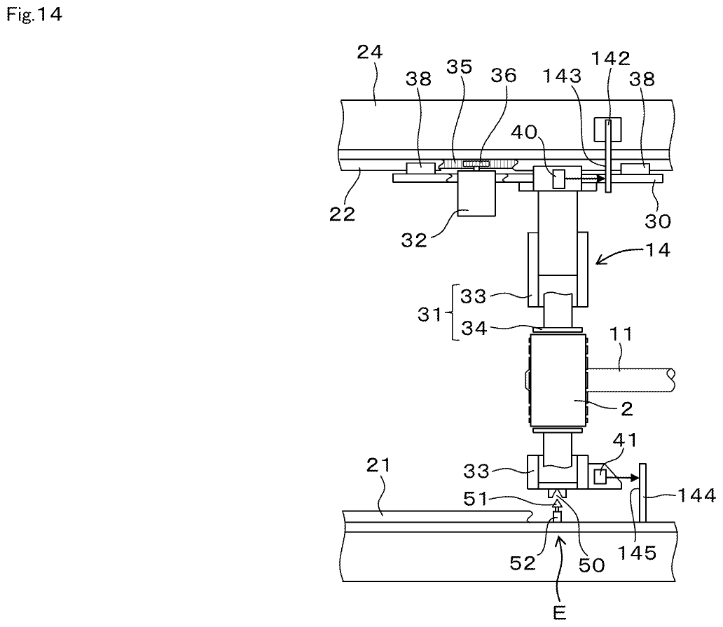

In the modification shown in FIGS. 13 and 14, an upper reflector 142 is disposed on a side surface of the upper frame 24 holding the third rails 22 at the delivering position E of the belt member 2 from the belt drum 11 to the second transfer device 14. The upper reflector 142 extends to a position lower than the third rails 22. The upper reflector 142 has a reflective surface 143 that is perpendicular to the direction in which the third rails 22 extend (which is also the direction in which the second transfer device 14 moves) and that faces the direction toward which the second transfer device 14 approaches. The reflective surface 143 faces the first laser displacement meter 40 of the second transfer device 14 when the second transfer device 14 is stopped at the delivering position E.

On the other hand, the first laser displacement meter is oriented in the same direction as the extending direction of the third rails 22 (which is also the moving direction of the second transfer device 14), whereby the measurement direction of the first laser displacement meter 40 is perpendicular to the reflective surface 143 of the upper reflector 142.

A lower reflector 144 on the floor at the delivering position E extends upward. The lower reflector 144 has a reflective surface 145 that is perpendicular to the direction in which the third rails 22 extend (which is also the direction in which the second transfer device 14 moves) and that faces the direction toward which the second transfer device 14 approaches. The reflective surface 145 faces the second laser displacement meter 41 of the second transfer device 14 when the second transfer device 14 is stopped at the delivering position E.

On the other hand, the second laser displacement meter is oriented in the same direction as the extending direction of the third rails 22 (which is also the moving direction of the second transfer device 14), whereby the measurement direction of the second laser displacement meter 41 is perpendicular to the reflective surface 145 of the lower reflector 144.

With such a configuration, when the second transfer device 14 stops at the delivering position E, the first laser displacement meter 40 can measure the distance to the reflective surface 143 of the upper reflector 142, and the second laser displacement meter 41 can measure the distance to the reflective surface 145 of the lower reflector 144.

Similarly, also at the delivering position C of the belt member 2 from the second transfer device 14 to the shaping drum 12, an upper reflector (not shown) having the same shape as the upper reflector 142 and a lower reflector (not shown) having the same shape as the lower reflector 144 are disposed. Then, when the second transfer device 14 stops at the delivering position C, the first laser displacement meter 40 measures the distance to the reflective surface of the upper reflector, and the second laser displacement meter 41 measures the distance to the reflective surface of the lower reflector.

(7) Seventh Modification

In the above-described embodiment, the measured distances from the laser displacement meters 40 and 41 to the reflectors 42 and 44 are acquired by the storage device 60. However, the measured distances from the laser displacement meters 40 and 41 to the reflectors 42 and 44 may be converted into distances from predetermined positions on the third rails 22 (for example, a regular stop position of the second transfer device 14), and the converted numerical values may be acquired in the storage device 60.

(8) Eighth Modification

The positioning device including the concave portion 50 and the cotter 51 can also be provided to stop the first transfer device 13. That is, the concave portion 50 may be formed in the first transfer device 13, the cotter 51 may be capable of advancing and retracting at a position where the cotter 51 faces the first transfer device 13 when the first transfer device 13 is stopped, and the cotter 51 may advance and be fitted into the concave portion 50 when the first transfer device 13 is stopped.

(9) Ninth Modification

The positioning device of the transfer devices 13 and 14 is not limited to that of the above-described embodiment. The positioning device may have any structure as long as it includes a concave portion and a convex portion, one of the concave portion and the convex portion is provided in the transfer device 13 or 14, and the other is provided at a position facing the transfer device 13 or 14 when the other is stopped, and the concave portion and the convex portion are fitted to each other to stop vibration of the transfer device. However, it is desirable to adopt a structure in which positioning is performed at a position on a side opposite to the rails 22 and 23.

In the above-described embodiment, the concave portion 50 is provided in the second transfer device 14, and the cotter 51 that is a convex portion is provided at a position facing the second transfer device 14 when the second transfer device 14 is stopped, but vice versa. That is, the transfer devices 13 and 14 may be provided with convex portions, and concave portions may be provided at positions facing the transfer devices 13 and 14 when the transfer devices 13 and 14 are stopped.

At least one of the concave portion and the convex portion is capable of advancing and retracting.

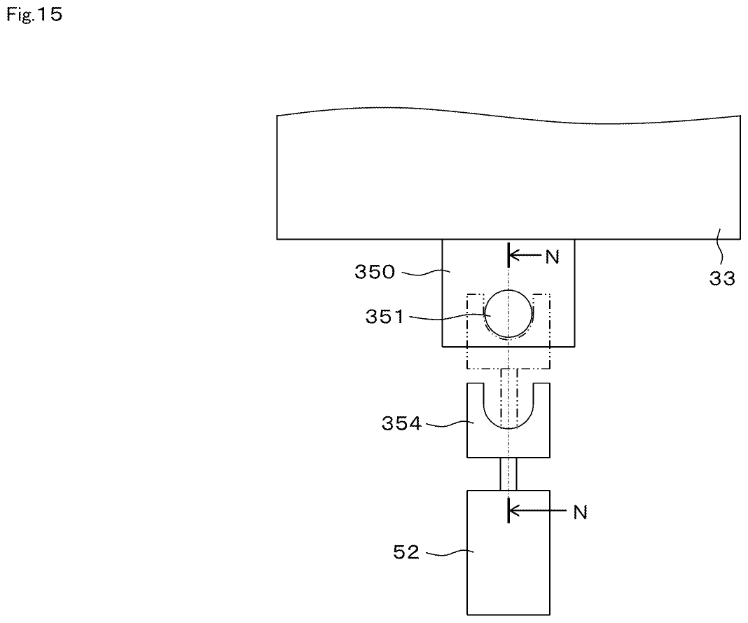

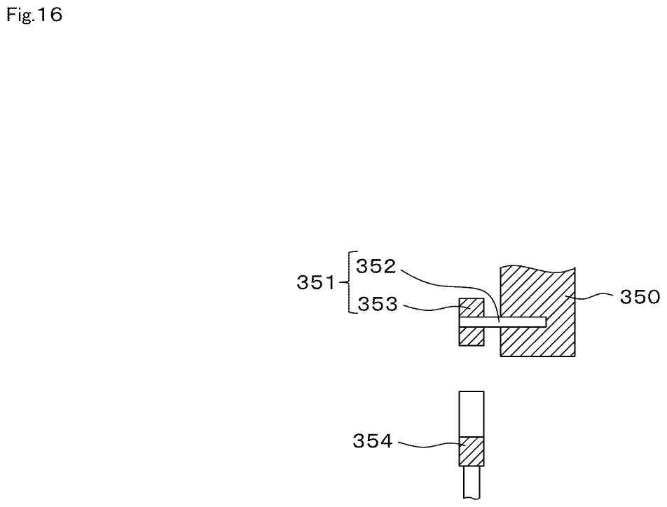

A positioning device according to a modification is shown in FIGS. 15 and 16. In this modification, an attachment member 350 is provided below the frame member 33 of the holding device 31 of the second transfer device 14. The attachment member 350 is provided with a cam follower 351. The cam follower 351 includes a rotation shaft 352 protruding from the attachment member 350 in a horizontal direction, and a rotation member 353 provided at a top end of the rotation shaft 352 and rotatable with respect to the rotation shaft 352. The cam follower 351 is a convex portion in the positioning device.

On the other hand, a U-shaped member 354 is provided at a position facing the cam follower 351 when the second transfer device 14 stops at the stop position. The U-shaped member 354 is capable of advancing and retracting by the cylinder 52. When the U-shaped member 354 retracts, the U-shaped member 354 has such a height that the U-shaped member 354 does not come into contact with the second transfer device 14. The inside of the U-shaped member 354 is a concave portion in the positioning device, and the rotation member 353 of the cam follower 351 can enter the concave portion.

When the second transfer device 14 stops at the stop position, the U-shaped member 354 advances as indicated by a two-dot chain line in FIG. 15, and the rotation member 353 of the cam follower 351 is fitted into the inside of the U-shaped member 354. As a result, the position of the second transfer device 14 is fixed, and swing of the second transfer device 14 is also absorbed.

The rotation member 353 of the cam follower 351 rotates and releases a force when coming into contact with the U-shaped member 354. Therefore, in the case of this modification, the cam follower 351 and the U-shaped member 354 are less likely to wear.

(10) Tenth Modification

The layout of the tire molding apparatus is not limited to those shown in FIGS. 1 to 6. Here, a modification of the layout of the tire molding apparatus will be described.

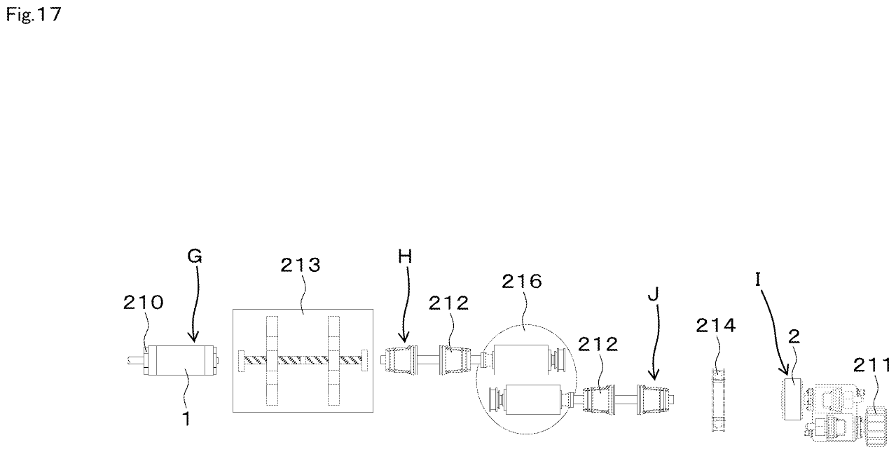

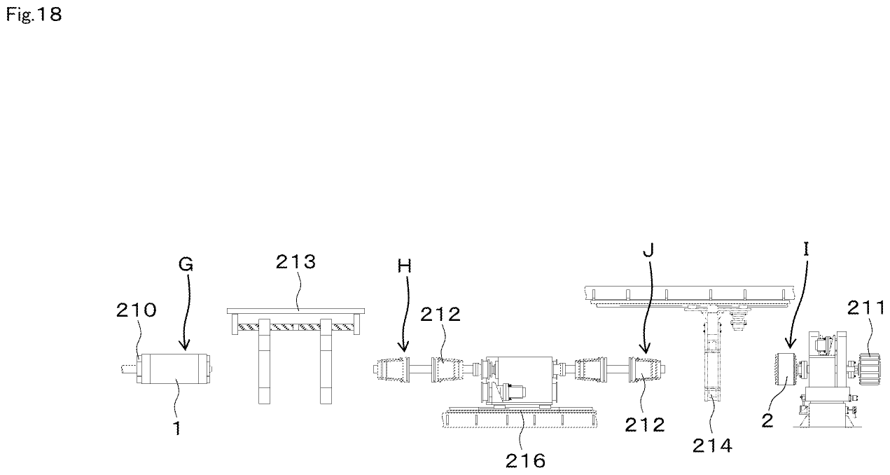

In the layout of the modification shown in FIGS. 17 and 18, two shaping drums 212 are provided on one rotary table 216 in opposite directions. Further, a carcass drum 210 is disposed on one side of the rotary table 216, and a belt drum 211 is disposed on the other side of the rotary table 216. One shaping drum 212 and the carcass drum 210 are arranged coaxially, and the other shaping drum 212 and the belt drum 211 are arranged coaxially.

Further, a first transfer device 213 is disposed between the one shaping drum 212 and the carcass drum 210, and a second transfer device 214 is disposed between the other shaping drum 212 and the belt drum 211. The first transfer device 213 is a device that receives the carcass band 1 from the carcass drum 210 and delivers the carcass band 1 to the shaping drum 212. The second transfer device 214 is a device that receives the belt member 2 from the belt drum 211 and delivers the belt member 2 to the shaping drum 212.

An outline of a tire molding method in the tire molding apparatus having this layout is as follows.

First, the carcass band 1 is molded on the carcass drum 210, and the belt member 2 is molded on the belt drum 211. Next, the first transfer device 213 moves from a standby position to a position G of the carcass drum 210 and stops. Then, at the position G, the carcass band 1 is delivered from the carcass drum 210 to the first transfer device 213.

Next, the first transfer device 213 moves to a position H of the shaping drum 212 and stops. Then, at the position H, the carcass band 1 is delivered from the first transfer device 213 to the shaping drum 212. For this delivery, the shaping drum 212 may move toward the carcass drum 210 in the axial direction.

Next, the rotary table 216 rotates by 180°, and the shaping drum 212 that has received the carcass band 1 faces the belt drum 211.

Next, the second transfer device 214 moves from a standby position to a position I of the belt drum 211 and stops. At this position I, the belt member 2 is delivered from the belt drum 211 to the shaping drum 212.

Next, the second transfer device 214 moves to and stops at a position J of the shaping drum 212 holding the carcass band 1. Then, at the position J, the belt member 2 is delivered from the second transfer device 214 to the shaping drum 212. As a result, the belt member 2 is disposed on the outer circumferential side of the carcass band 1 held by the shaping drum 212. For this delivery, the shaping drum 212 may move toward a belt drum 211 side in the axial direction.

Next, shaping is performed on the shaping drum 212, and the carcass band 1 and the belt member 2 are integrated to complete a green tire.

In the tire molding apparatus as described above, the concave portion 50 is provided in at least one of the first transfer device 213 and the second transfer device 214 in a similar manner as in the above-described embodiment. The cotter 51 is provided at a part or all of the stop positions G, H, I, and J of the first transfer device 213 and the second transfer device 214 to be capable of advancing and retracting in a similar manner as in the above-described embodiment. Then, when the transfer device is stopped, the cotter 51 advances and fits into the concave portion 50 to position the transfer device and stop swinging of the transfer device.

(11) Eleventh Modification

The positioning device of the above embodiment has a structure in which the concave portion 50 is provided in the lower portion of the second transfer device 14, and the second transfer device 14 is stopped at a part on a side opposite to the third rails 22.

However, the positioning device only needs to be able to stop the swing of the second transfer device 14. Therefore, it is only necessary that a concave portion (or a convex portion) is provided in any part of the second transfer device 14, a convex portion (or a concave portion) is provided at a position facing the concave portion (or the convex portion) of the second transfer device 14 when the second transfer device 14 is stopped, and the concave portion and the convex portion are fitted to each other. The positioning device is provided at a position away from the third rails 22.

For example, in the case where the third rails 22 are provided above the second transfer device 14 as in the above-described embodiment, the concave portion 50 may be provided in a side portion of the holding device 31 of the second transfer device 14 (left and right parts of the holding device 31 in FIG. 7) or in the vicinity thereof, the cotter 51 may be provided at a position facing the concave portion 50 when the second transfer device 14 is stopped, and the cotter 51 may be fitted into the concave portion 50.

In the second transfer device 14, one of the concave portion and the convex portion of the positioning device may be provided at a position farther from the third rails 22 than the center of the circle formed by the segments 34, and the other of the concave portion and the convex portion of the positioning device may be provided at a position facing the one in the second transfer device 14 when the second transfer device 14 is stopped, and the concave portion and the convex portion are fitted to each other.

### REFERENCE SIGNS LIST

1: carcass band
2: belt member
3: bead
10: carcass drum
11: belt drum
12: shaping drum
13: first transfer device
14: second transfer device
15: rotary table
16: rotary table
20: first rail
21: second rail
22: third rail
23: fourth rail
24: upper frame
31: holding device
32: servo motor
33: frame member
34: segment
35: rack
36: pinion
37: extension member
38: slide member
40: first laser displacement meter
41: second laser displacement meter
42: upper reflector
43: reflective surface
44: lower reflector
45: reflective surface
50: concave portion
51: cotter
52: cylinder
54: support base
55: moving device
56: support base
57: support base
58: moving device
60: storage device
61: determination unit
62: display unit
142: upper reflector
143: reflective surface
144: lower reflector
145: reflective surface
210: carcass drum
211: belt drum
212: shaping drum
213: first transfer device
214: second transfer device
216: rotary table
350: attachment member
351: cam follower
352: rotation shaft
353: rotation member
354: U-shaped member

1. A tire molding apparatus comprising:
a rail; and
a transfer device configured to hold a tire member and move along the rail, wherein
the transfer device is configured to move along the rail and stop to receive or deliver the tire member,
a positioning device is provided in the transfer device,
the positioning device includes a concave portion and a convex portion,
one of the concave portion and the convex portion is provided in the transfer device,
the other one of the concave portion and the convex portion is provided at a position facing the transfer device when the transfer device is stopped, and
the transfer device is stopped by fitting the concave portion to the convex portion.

2. The tire molding apparatus according to claim 1, wherein
the convex portion is a cotter or a cam follower.

3. The tire molding apparatus according to claim 1, wherein
the transfer device is moved by a servo motor.

4. The tire molding apparatus according to claim 1, wherein
the transfer device includes a plurality of segments arranged in a circular shape for holding the tire member, and
one of the concave portion and the convex portion is provided at a position farther from the rail than a center of a circle formed by the plurality of segments.

5. The tire molding apparatus according to claim 1, wherein
one of the concave portion and the convex portion is provided in a part of the transfer device on a side opposite to the rail.

6. A method for receiving or delivering a tire member, the method comprising:
providing a rail and a transfer device configured to hold a tire member and move along the rail;
moving the transfer device along the rail and stopping the transfer device at a stop position for receiving the tire member from another device or delivering the tire member to another device; and
mechanically fixing a position of the transfer device at the stop position after moving the transfer device to the stop position and stopping the transfer device.

7. The method for receiving or delivering a tire member according to claim 6, wherein
the transfer device is moved and stopped by a servo motor.

8. The method for receiving or delivering a tire member according to claim 6, wherein
the transfer device includes a plurality of segments arranged in a circular shape for holding the tire member, and
the mechanical fixation is performed at a position farther from the rail than a center of a circle formed by the plurality of segments.
